(19) United States
(12) Patent Application Publication
(10) Pub. No.: US 2009/0150833 A1
(43) Pub. Date: Jun. 11, 2009

(54) Screen saver with customized content, time of activation capture and reporting for the purpose of providing a usage incentive

(76) Inventors: Floyed Jeffries Duncan, JR., Brentwood, TN (US); Donald Larry Walker, JR., Hendersonville, TN (US)

Correspondence Address: Jeff Duncan, 9546 Hampton Reserve Drive, Brentwood, TN, 37027, US

(21) Appl. No.: 11/999,988

(22) Filed: Dec. 10, 2007

(51) Int. Cl. G06F 3/048

(52) U.S. Cl. 715/867

(57) ABSTRACT

A screen saver utilizing screen content that is provided from a remote server and optionally selected based on the end-user's inferred interest in previous content. Further functionality in the screen saver that would monitor the level of usage (such as time that the screen saver is active) and report this to a central server where a “lottery like” selection of a winner(s) would be made. The winner(s) would then be provided a prize and optionally featured in subsequent screen saver content. The purpose of the above scheme being to create an incentive for usage of the screen saver which would include content that has advertising or other value to a sponsoring entity.

### DEFINITIONS

Click thru—The ability to drill into information presented on a display to obtain additional relevant detail. In the case of this patent, an area of interest existing in the Lottery ScreenSaver display content would have the ability to be selected for the purpose of obtaining additional information. Activation of the “click thru” feature would be accomplished by a mouse and/or keyboard action that would reference and display additional information regarding the subject selected. This is much the same as a link embedded in a web page with the exception that alternative key stroke and/or mouse actions may be employed to provide access versus a typical mouse action that would otherwise terminate the screen saver.

Client or Host applications—The software envisioned herein consists of two portions; 1) The client which is an enhanced version of a computer screen saver and 2) the host or server application which provides registration functionality, usage data collection and content distribution; each of which will be implemented in plurality.

Lottery ScreenSaver—this term is utilized throughout referring to the patent content in its preferred embodiment. The “Lottery ScreenSaver” is a computer screen saver equipped with the usage tracking capability described herein resulting in the end-user's participation in a lottery associated with use of the screen saver.

Sponsor or sponsoring entity—In the preferred embodiment, a plurality of systems described herein would be in place, each of which would be funded and managed by or on behalf of a sponsoring individual or organization.

### BACKGROUND OF THE INVENTION

Traditional marketing techniques using the new tools of Web 2.0 are effective by traditional measures, but do not exploit the new opportunities afforded by the web technology. Mass customization of products has shown tremendous benefit in industries as diverse as computers and blue jeans. The concept of tailoring an offering to the specific needs of unique end-users and doing so using automated volume scalable techniques is a fundamental concept of mass customization. Producing a value adding proposition with this mass customization concept applied to advertising and brand exposure is one of the primary intents of the preferred embodiment of this patent. In addition, a compelling incentive to expose the advertising and brand content and to proliferate exposure in other venues by way of an end-user friendly viral marketing scheme is encompassed in the patent. The technique taught in this patent creates an analogy to mass customization in manufacturing for the communication of brand, product or service attributes. Content is selected or customized based on the interests passively exhibited by the end-users. Attempts to react to an end-user's areas of interest traditionally are responsive to a proactive request by the end-user for more information via following a link, filling out a punch card, email, phone call, etc. The technique taught here would passively monitor areas that an end-user explores within a screen saver and select or customize future content to be responsive to this knowledge. Traditional screen saver technology has included promotional and advertising content but has not exposed the opportunity to customize future content based on a passive indication of interest (“click thru” tracking).

In addition, a powerful incentive, that of free participation in a lottery is provided in consideration of accepting an exposure to the content of the screen saver. Traditional lotteries have in some cases utilized electronic means to collect individuals participating, typically on a pay-per-chance basis. The unique concepts herein provides an incentive, participation in the lottery, for users to enable a screen saver with controlled content to be displayed rather than requiring a fee for lottery participation. Lotteries have typically paid out a portion of the proceeds from ticket sales; in this concept the lottery winnings are based on a payout of a fraction of the value of the exposure gained by the use of the Lottery ScreenSaver. The lottery concept both encourages an end-user to participate in the program, and also offers a compelling viral spread of the program through word of mouth, direct or electronic, and an installation route that is easy and intuitive.

US Patent classification 715 “Data processing: presentation processing of document, operator interface processing, and screen saver display processing” addresses the technology category of this patent. Sub category 867 “Screen Saver Display” further details art associated with “Subject matter wherein a small program takes over the display screen if there are no keystrokes or mouse movements for a specified duration”.

Investigation of these and other potential classifications revealed only a few filings that border on the claims made herein. Description of each of these instances of prior art and the unique distinction claimed in this filing are described below:

Prior art by Knepper in U.S. Pat. No. 6,763,272 teaches of a general purpose screen saver that was considered relative to interfering with the scheme proposed herein, however, specifics in the three independent claims of 272 show clear lack of overlap. In independent claim #1 an “activation element for remote-controlled cancellation of the screen saver function” is specified. The scheme of this proposal includes no such remote controlled cancellation. Independent claim 16 specifies use of a detector of “other than manual activation” to disable the screen saver. Deactivation of the screen saver in this application will depend on manual activation of either the keyboard or a mouse. Last, independent claim #17 requires “at least two displays” to be engaged in the claim, this is not the case in the proposed claims.

Prior art by Yuval Rakavy et al encompassed in U.S. Pat. No. 5,913,040 teaches of advertising or other information being selectively transmitted to a client computer for display. The patent, however, specifically requires the end-user to provide for “user input at the local computer as to the types of advertisements which are to be displayed”. It is also stated that the object of the patent is “to provide a method and system of presenting individualized advertisements and other information messages on a computer by allowing a user to select from a variety of advertisement of information categories.” Both of these references from the Background and Summary sections of the 040 patent, show a fundamental differentiation from the present patent in that the selection of screen saver content to be provided herein is either predetermined or based on an analysis of the “click thru” data reported to the host server. In no case is the user asked or allowed to select the content that would be presented in subsequent Lottery ScreenSaver sessions. More specifically, Independent claim 1 or the 040 patent states the “inputting of user priorities” in step “a” which differs fundamentally from the claimed scheme. Dependent claims 2 and 3 do not offer any differing practice in this regard. Independent claim 4 teaches of the same requirement in step “a” and likewise for claims 4 and 5 which are dependent to 4. The remaining claims speak to monitoring and adjusting files transmissions in response to the “utilization rate of the communications link” which is not pertinent to the claims herein.

U.S. Pat. No. 6,251,017 by Inventors: David Leason, Scott L. Sullivan discloses the concept of an Internet based lottery whereby the issuance and entry of a validation code at a designated web site is utilized to register user such that they could be provided a benefit which could be a “promotional game or lottery”. The scheme taught in the current patent does not utilize any validation code or require such to be entered into a website.

U.S. Pat. No. 6,920606 teaches of a marketing system allowing “click thru” capability but differs in that that capability is embedded in a wallpaper on the screen in 33 of the 34 claims. The remaining claim, dependent claim 10 teaches of “including a screen saver feature that moves the click-able icon across the visual display”. No such icon or movement is envisioned in the current patent.

U.S. Pat. No. 6,516,338 by Landsman & Lee describes a application where advertisements are selected by the system in response to user input, but all claims limit the initiations of such activity to that “by a browser in the client computer” The claims made herein are limited to content “click thru” from a screen saver and are thereby differentiated from 338.

U.S. Pat. No. 5,740,549 teaches of a technique similar to U.S. Pat. No. 5,913,040 in that claims 1 and the remainder of subsequent dependent claims 2-20 all rely on the content displayed being based on user selected preferences and the current patent is thereby differentiated.

Numerous patents are involved in attempting to protect the basic function of a screen saver. It should be noted that the claims herein do not attempt to claim the screen saver function itself, but rather add to the basic functionality in the areas of proactively determining the content to be displayed and logging and reporting various aspects of the screen saver usage. As such, the art claimed in the patents below, which attempt to cover the fundamental screen saver function were examined and found not to be in conflict with the scheme proposed herein.

U.S. Pat. No. 5,305,195—Interactive advertising system for on-line terminals

U.S. Pat. No. 6,486,900—System and method for a video display screen saver

U.S. Pat. No. 6,353,449—Communications Screen Saver

### BRIEF SUMMARY OF THE INVENTION

A customizable screen saver provided with the ability to track and report activations, activation durations and specifics of “click thru” activity of content. Screen saver installation also includes a registration function to capture user specifics in a centrally managed host server. On a routine basis, potentially weekly, the Lottery ScreenSaver clients report usage to a central server. Subsequently, the data reported is utilized to perform a lottery type selection of a winner with the chances of winning optionally being a function of the duration of screen saver activation during that week. Data regarding the “click thru's” on screen saver content may also be analyzed by the server and used to influence subsequent content that is downloaded to the Lottery ScreenSaver client for display.

Additional capabilities include separate tracking of activation during different time periods such as working hours or Monday thru Friday, collection of information that may be used to enhance the odds of winning the lottery, the collection of user information for development of targeted mailing lists and/or functionality within the Lottery ScreenSaver client to spawn emails to others to encourage and assist them in installation of the Lottery ScreenSaver. The sponsoring organization of the Lottery ScreenSaver, would maintain control of the display content, lottery specifics, user registration and user information collected.

The implementation of such a screen saver will provide the sponsoring organization the ability to push selected and optionally mass customized information to the screen savers of end-users in volume. The incentive for end-users to enable the Lottery ScreenSaver is controlled by the sponsor as a function of the desirability of the prizes they choose to provide to the winner(s) of the lotteries. In total, the concept offers a new and robust opportunity for end-user advertising to be made in a manner that the end-user is incented to participate and in a manner that can include more rich media than in traditional banner ads or email campaigns.

### DESCRIPTION OF THE DRAWINGS

FIG. 1 describes the overall conceptual flow in the preferred embodiment of the patent. Steps 1 through 6 are described in detail in subsequent figures. Note that this concept would be implemented in plurality with unique content options and enticements from numerous sponsoring entities. In FIG. 1, step 1.0 consists of a numerous methods of distributing the Lottery ScreenSaver software to end-users. Typically the intent would be to encourage and enable a broad distribution as this is essentially proportional to the advertising and awareness exposure that will be gained from the Lottery ScreenSaver. Step 2.0 includes the Lottery ScreenSaver client software installation on an end-user's computer or device, the optional setup selections for the screen saver operation and a registration step for the end-user to complete including an end-user licensing agreement if desired. Step 3.0 represents the routine use of the screen saver with the notable difference that the activation and duration times as well as any “click thru” activity on screen saver content would be logged on the client computer. The Lottery ScreenSaver would also provide functionality to invite others via an email to install the software thereby enabling a viral marketing distribution capability. Step 4.0 occurs on some occasional basis, potentially weekly at which time the client machine connects to a host sever and transfers data identifying the ID of the end-user, the activation times and duration, and the identity of any “click thru” actions from screen saver content. Step 5.0 also occurs on an occasional basis potentially concurrent with step 4.0, whereby the host determines the content desired to be displayed on the end-users' screen savers and transfers or provides pointers to any content not already resident on the client. The Lottery ScreenSaver would subsequently use this content until a future update is processed. Step 6.0, participation in a lottery, is a unique incentive for the end-users to install and utilize the Lottery ScreenSaver, thereby providing marketing exposure for the sponsoring entity. With the odds of winning based on the cumulative activation time of the screen saver or optionally other criteria, a lottery selection of a winner or winners would be made on a routine basis. The winner would be notified traditionally and/or communicated by way of inclusion as a portion of subsequent Lottery ScreenSaver content update.

FIG. 2 describes in more detail the steps of distribution and installation of the software. One or more of numerous distribution techniques could? be utilized to make the Lottery ScreenSaver software available to end-users. These might include, but are not limited to, the methods listed in 1.2.1 to 1.2.7 of the figure. In a preferred embodiment, the desire would be to expose and install as many end-users as possible thereby increasing the advertising value of the concept. The optional methods of distribution described in FIG. 2 include:

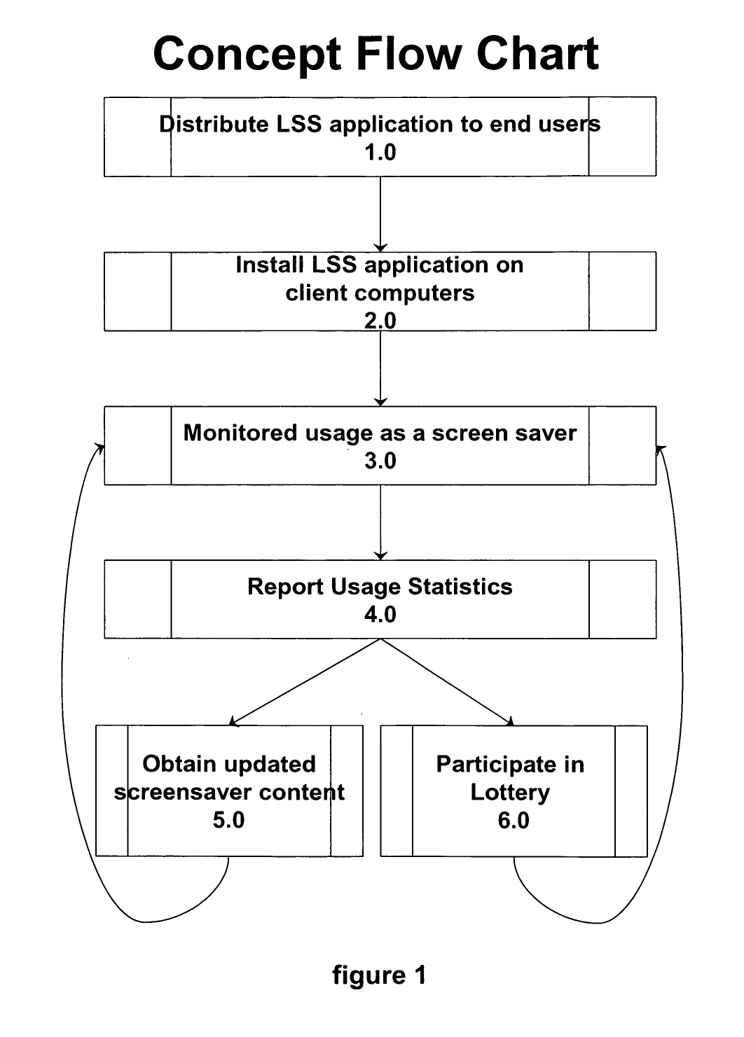

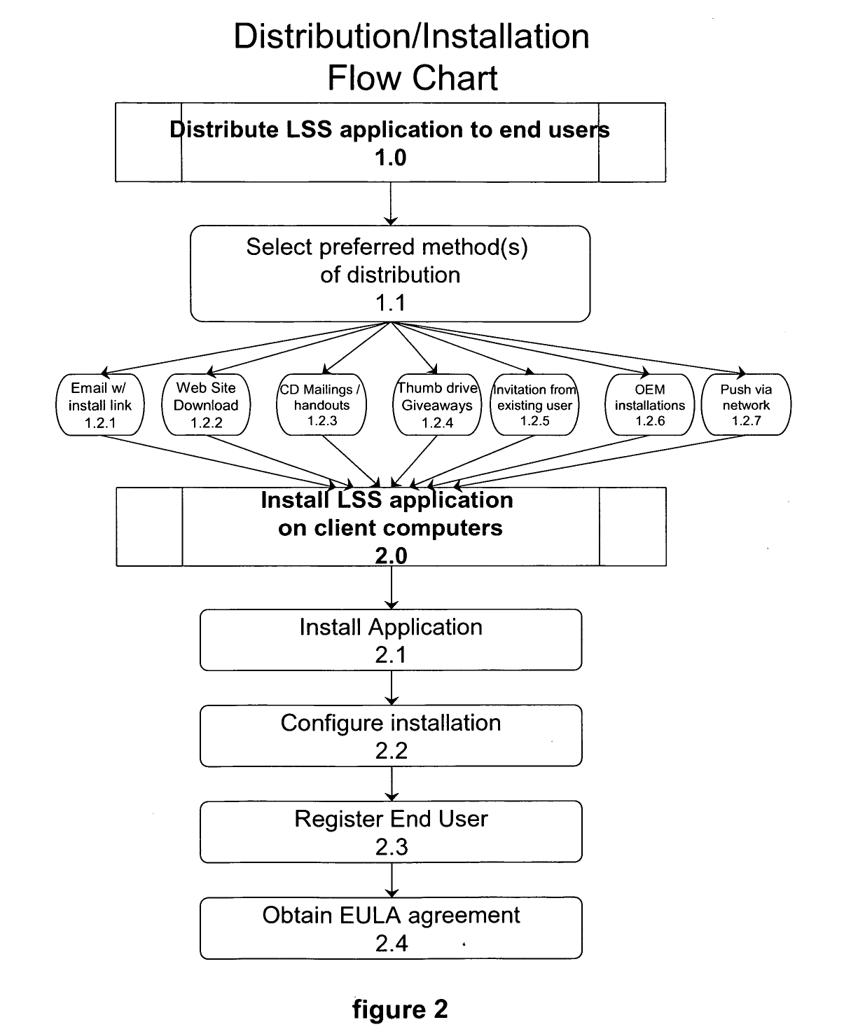

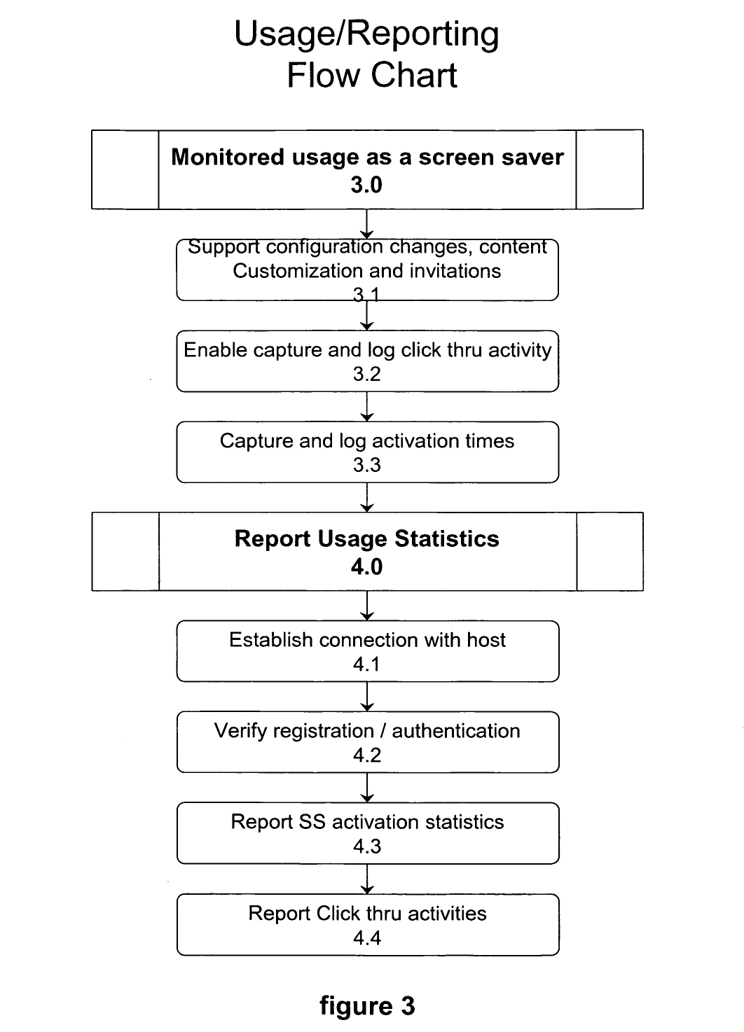

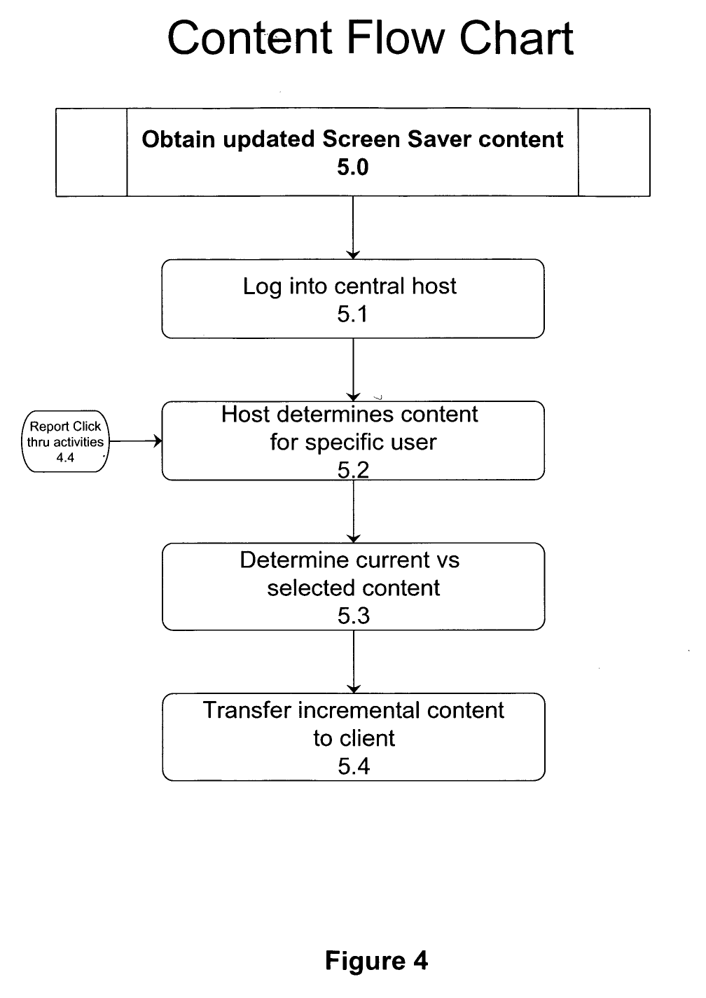

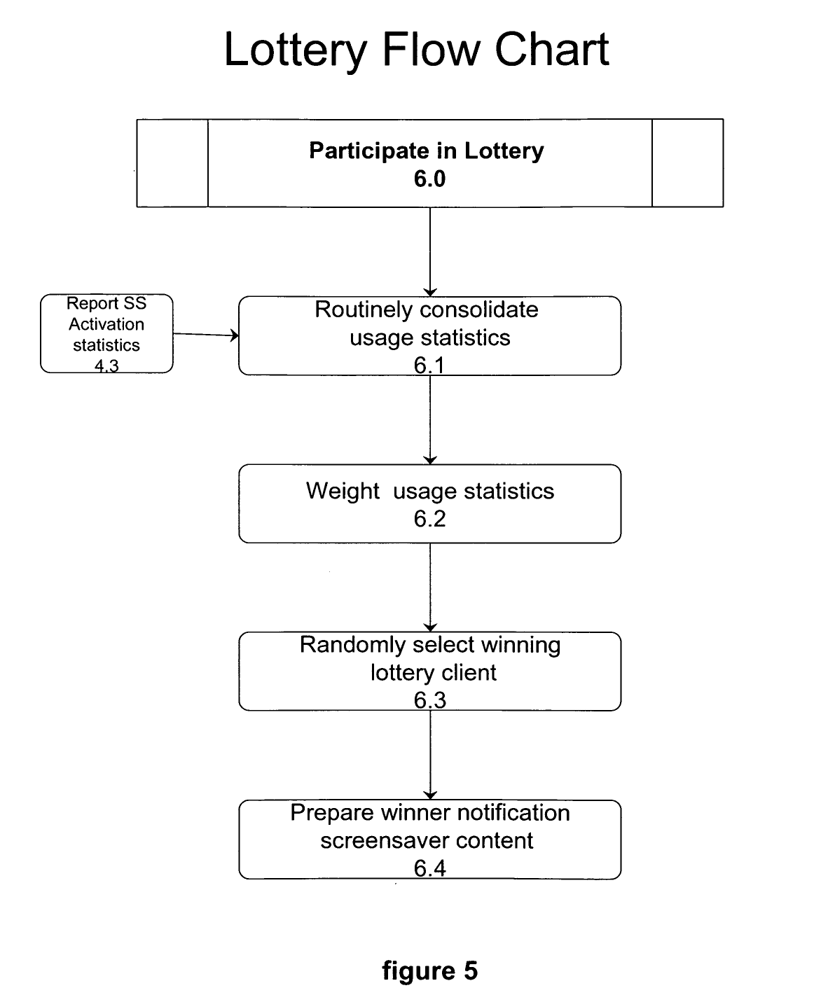

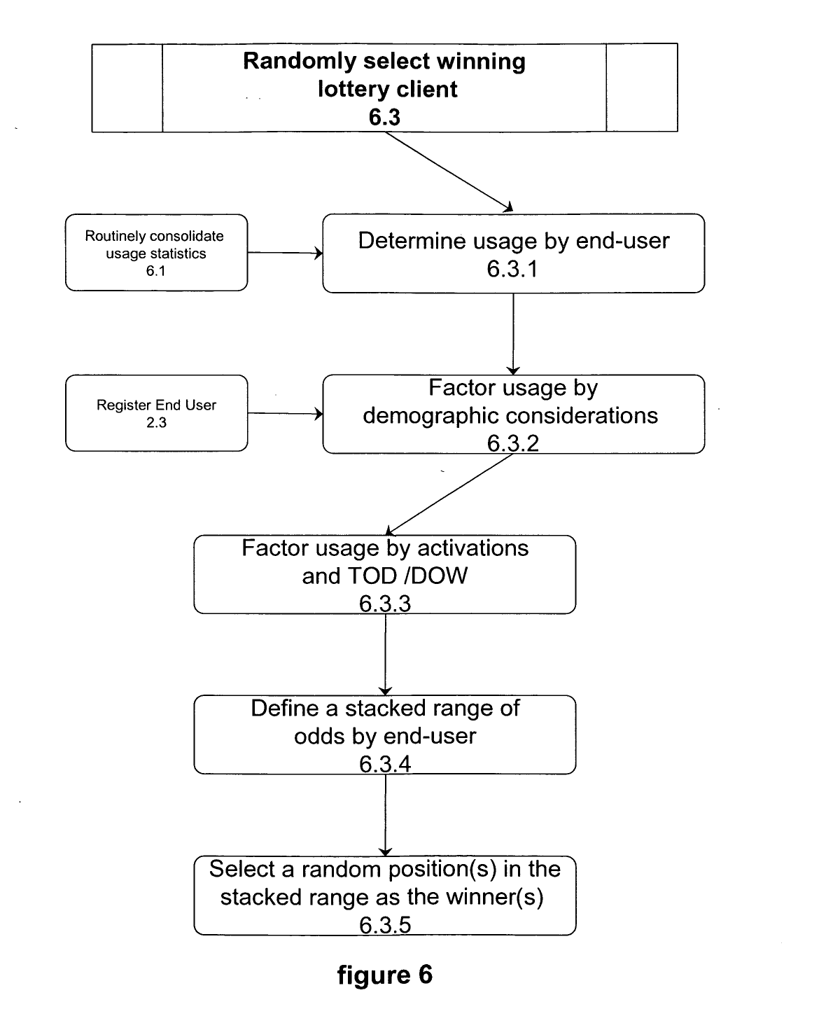

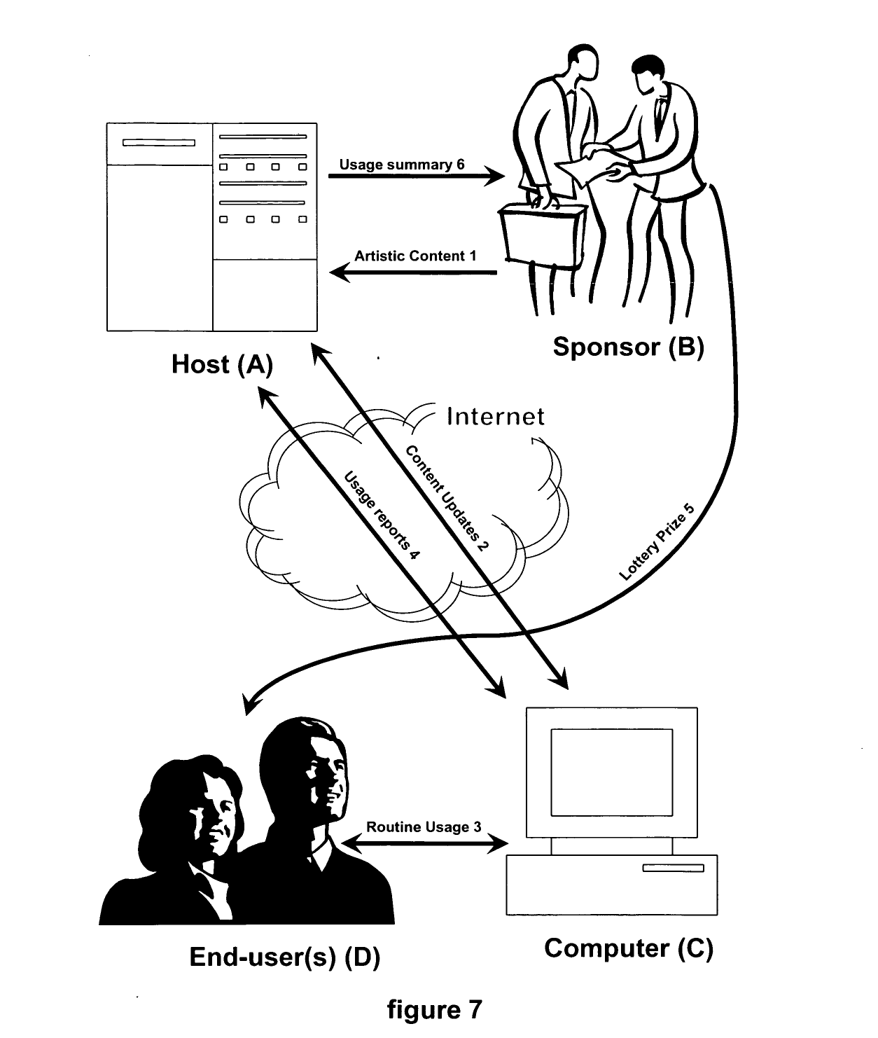

1.2.1—Solicited or unsolicited emails with links to the Lottery ScreenSaver software installation files

1.2.2—Access to download links on sponsor's webs sites, or other affiliated websites. Potential end-users could be directed to these sites in promotional literature, mass media advertising or otherwise.

1.2.3—Mailing CDs or other media in the traditional postal service or like with promotional material or handed out at trade shows or other similar venues

1.2.4—Software could be preloaded onto thumb drives, disks or other portable media and distributed freely

1.2.5—Functionality can optionally be provided in the Lottery ScreenSaver itself to send an invitation via email to potential end-users whereby a personal message could be included with the invitation which would also include a link to the software installation files.

1.2.6—Arrangement could be made with OEM computer or mass media providers whereby Lottery ScreenSaver software or numerous Lottery ScreenSaver versions would be pre-loaded in new computers or on mass storage devices.

1.2.7—On corporate or other proprietary networks where administrators have the ability to push software to individual client devices or computers, the Lottery ScreenSaver could be installed and optionally locked down to eliminate the user from selecting an alternative screen saver.

After access to the installation software is obtained by whatever means is utilized, step 2.1 provides for the installation of that software on a client computer or device. Installation could? be performed by an installation wizard or through other means which are user friendly for the operating system on which the software is being installed. After installation and whenever configuration changes are desired by the end-user a configuration screen represented in step 2.2 would be made available to the end-user. Configuration of the Lottery ScreenSaver would include both traditional screen saver settings as well as additional information needed for the unique functionality of this concept. Routine configuration in step 2.2 would include but not be limited to:

1. Period of inactivity prior to screen saver activation

2. Option to require log-on password when screen saver is exited

3. Preview of screen saver

Additional information that would be required during configuration of the concept screen saver would include confirmation that the end-user is a registered Lottery ScreenSaver user. For those users not yet registered, a link would also be provided to become registered as referenced in step 2.3.

Step 2.3 would consist of obtaining end-user information and registering it on a host server. The registration step would ensure that anyone using the Lottery ScreenSaver and entering the lottery would be properly identified and therefore able to be reached in the event that they become a lottery winner. Registration also optionally allows for the creation of mailing lists, collection of demographics and ability to ensure that the lottery chances of any individual are not higher than may be reasonable, indicating that the integrity of the lottery might have been compromised. The registration would also optionally allow the collection of other end-user data as may be desired by the sponsoring organization. Such data as proof that the end-user is a current customer, a targeted customer or demographic or any other criteria that may be envisioned could be collected through the registration and optionally used to provide a multiplying factor for targeted end-users improving their odds of winning the lottery. One embodiment of this concept would be that whenever a valid serial number of a sponsor's product was entered into the user's registration information, their odds would be increased by 20%.

As a prerequisite to completing the registration, an End-user Licensing Agreement represented in step 2.4 would also be agreed to. Terms of the agreement would optionally include, but not be limited to, permission to use the end-user's name and other information in promotional material, including Lottery ScreenSaver content, should they be a winner of the Lottery.

FIG. 3 describes the functionality of the Lottery ScreenSaver in routine operation. Section 3.0 consists of the routine functionality of a screen saver (not shown), including but not limited to activation after a period of inactivity, replacing the screen content with a graphic or other visual and optionally providing for password protection when deactivating the screen saver. Section 3.1 refers to several additional abilities of the Lottery ScreenSaver that would be available during routine operation which may include but are not limited to:

1. To modify the configuration initially set up in step 2.2,

2. The ability for the content of the screen saver images to be customized during the routine use of the screen saver,

3. The ability to spawn an email to any valid email address for the purpose of informing the recipient of the Lottery ScreenSaver and providing a link or other means of enabling installation of the Lottery ScreenSaver. The ability for the end-user to include a custom message in the email would also be optionally available

Step 3.2 provides for the ability of the Lottery ScreenSaver to alternatively allow the end-user the ability to “click thru” on information of interest in the screen saver content. This would be accomplished by enabling a specified action, such as pressing the escape key or F1 key, such that when this action is taken, additional information would become available, or the content on the screen saver would become active links instead of being dismissed when keyboard or mouse activity occurs as in a typical screen saver. If a password and log-on from screen saver activity had been selected in the screen saver options, the log-on security credentials would need to be satisfied to enable “click thru” features as well.

Step 3.3 represents the feature set that monitors the screen saver activations. This includes both the duration of activations as well as optionally the time of activation during certain periods of the day or week. The latter allowing a sponsor of a version of the Lottery ScreenSaver to only recognize activation during specific times such as 9 to 5 on weekdays or to weight the minutes of usage during different time periods differentially if desired.

Step 4 in FIG. 3 addresses the occasional reporting of data collected during routine operation. This step would typically be scheduled on a routine basis, likely weekly or as often as the sponsor desires. Each session would begin with establishing a connection with the host (step 4.1), typically through the Internet or other similar network connection and ensuring the identity and registration of the client reporting (step 4.2) via a user name and password or other accepted means. One or both of the steps in 4.3 and 4.4 can take place during a reporting session. Step 4.3 consists of reporting the data regarding activations since the last report. This would include information such as the number of activations and duration of activations as well as optional segregation of this data into various time of day and/or day of week categories if this granularity is desired for determining lottery odds or for other purposes. Step 4.4 reports on the number and identification of “click thru” activity since the previous reporting. This data would be used to infer an end-user's affinity for various content with the potential to target future content of the Lottery ScreenSaver or thru other communication means thru mass customization.

FIG. 4 describes the ability of the concept to update or refresh the content of the Lottery ScreenSaver. This content may be a combination of images, video, audio or hybrid media such as Flash® or Silverlight® content. The client application will occasionally, typically on a weekly basis or less, log into the central host (step 5.1), be authenticated as a registered client and obtain a download or links to updated content. The updated content may be mass customized for the individual user as described in step 5.2. In this step, data from previous “click thru's” reported in step 4.4 could be utilized to identify areas where the end-user had followed a link for additional information on a particular area. Future content could be identified as appropriate to further engage the end-user in that area and, therefore, be included in the content to be used in future Lottery ScreenSaver activations. Future content selected could also include promotional information stating the prizes available for the upcoming Lottery ScreenSaver winner(s). Step 5.3 would compare the Lottery ScreenSaver content already available to the client versus that determined in step 5.2 and delete any content not needed in the future as well as transferring content or links to content (step 5.4) for any new content needed.

FIG. 5 describes participation in the lottery portion of the concept. In this process usage of the screen saver is collected and consolidated on the host server in step 6.1 with input previously described in section 4.3. If a weighting scheme is utilized, the chances of an individual user winning would be calculated based on this weight in step 6.2. Weighting would typically be based on the number of activations, the total duration of activations, the time of day or time of week of activations and/or any demographic data of the end-user as desired by the sponsor (such as being a current or potential customer or in market segment of interest). Once the chances of each user are identified, they would be compiled and based on those chances a random selection of a winner or winners would be made in section 6.3. Lastly the winner(s) of the lottery would be notified of their fortune and optionally featured for publicity in future content of the Lottery ScreenSaver (step 6.4). Prizes awarded to the lottery winner(s) could be anything desired by the sponsor of the lottery.

FIG. 6 provides a description of a preferred embodiment of the random selection of a lottery winner. In step 6.3.1 information from the end-user's utilization of the screen saver is determined for each end-user from data obtained in section 6.1 previously discussed. For each user, an integer number of “points” would be determined using an algorithm as agreed to by the sponsor and disclosed to end-users. A typical algorithm might be one point for each minute of screen saver activation up to 12 hours per day. An additional point for each minute of activation for usage between the hours of the typical work day (ie: 9 am and 5 pm), on weekdays and 2 points for each activation up to 50 per day. Step 6.3.2 depicts the option of providing a factor for selected demographics such as customers, or individuals involved in a particular industry, those in a particular geographic area of focus, etc. This data would typically be determined during the registration step 2.3. If a factor is desired, the integer determined in step 6.3.1 would be multiplied by some predetermined factor, for example 2×. Finally a stacked range of integers would be determined represented by step 6.3.4 such that a range of integers would be assigned to each end-user and the complete range of integers would equal the total points of all the end-users. By doing this, when a random number between 1 and the sum of the range is selected in step 6.3.5, the appropriate odds of each user would have been considered. Step 6.3.5 may be performed more than once if more than one winner is desired to be selected.

FIG. 7 depicts the overall flow in the preferred embodiment of the process taught in the patent in routine use, i.e. after initial installation and registration. This embodiment would be implemented in plurality as desired/supported by sponsors. Four primary components are in play designated by A-D in the figure. Host (A) represents a remote server running the Lottery Screen Saver host application. This would typically reside on high reliability/scalability hardware in a data center with high bandwidth and data/power redundancy. Sponsor (B) represents the individual or entity that is utilizing the Lottery ScreenSaver scheme to promote their product or service. They would maintain the Host (B) or have it done on their behalf. In addition, they would arrange and promote the distribution of the client software and provide for the prizes given to lottery winners. Computer (C), the client device, would have the Lottery ScreenSaver client software installed and would typically be an end-user PC or workstation or any device capable of displaying information. These display devices would be implemented in plurality for each host computer. End-user (D) would be the user(s) of the client computer or device, they are the target of the promotional effort and the participant and potential winner in the lottery. In step 1, as depicted in the figure, creative content to be displayed on the screen saver is provided by the Sponsor (B) to the Host (A). In Step 2, the host updates a selection of this content to the client computer (C). Step 3 represents the routine use of the computer by end-users (D), during this time the end-users would be exposed to the content of the screen-saver, and would optionally drill down or “click thru” into the content for additional information in areas of interest. During routine usage, the client software would monitor and record details of screen saver activation, duration of activations and “click thru” activity. In Step 4, on an occasionally basis as desired by the sponsor, the client would transfer this usage data to the Host (A). Based on the end-users' usage of the screensaver and optionally weighted by the nature of their usage or other criteria, a lottery winner or winners would be routinely selected and provided a prize as their fortune as indicated in Step 5. Finally usage summaries would be provided to the sponsoring organization to provide an indication of impressions made and to potentially influence future screen saver content. The process then repeats itself starting again with Step 1.

### DETAILED DESCRIPTION OF THE INVENTION

In the preferred embodiment a “screen saver” like functionality is provided with routinely customized and updated content. The content of the screen saver is tailored to the desires of the sponsor organization. Different versions would be produced for various sponsors providing a differentiated content that would be responsive to their advertising, brand awareness, product attributes or otherwise at the sponsors discretion. The Lottery ScreenSaver provides opportunity to link to addition local or online details and follow-up opportunities via “click thru” capability. The proprietary screen saver functionality claimed in this patent would register end-users and track numerous details of usage and report this usage to a host computer. Information tracked may include, but not be limited to the time of day, date and duration of screen saver activations as well as the links on the screen saver that are selected via “click thru's. This data along with end-user identifying information will routinely be transmitted back to a host application run by or on behalf of the sponsoring organization. Usage data will then be used to enter the registered end-users into a lottery run by, or on behalf of the sponsoring organization. The lottery chances would optionally be weighted by the amount of exposure the screen saver provided (minutes of screen saver activity, number of screen saver activation, time of day, etc.). “Click thru” data could be used to target future screen saver content to areas of evident interest of the end-user or otherwise based on an analysis of the data and desire of the sponsor. Lottery winners would be selected from end-users on a routine basis as a reward for using the Lottery ScreenSaver and as an incentive to proliferate more usage. Winners would optionally be featured in future Lottery ScreenSaver content to further exposure and incentive for increased participation. Functionality may optionally be provided from within the client application to send a link to others via email or text message that would encourage and facilitate them to install the screen saver and participate in the program. An option to weight the lottery chances based on other criteria, i.e. whether the end-user is a current or prospective customer, commercial vs. private end-user, time of day usage occurred or otherwise as desired by the sponsoring organization could be included based on information provided during installation, registration, operation or otherwise.
a. Distribution of the software could be unrestricted and facilitated through such means as Internet downloads, giveaway CD's or thumb drives at trade shows, point of sale displays, with routine mailings, encouraging end-users to share the software, etc. During installation of the screen saver software a registration process would gather end-user specific information as well as requesting permission for exposure of their identity should they become a lottery winner. In a preferred embodiment a weekly lottery would be run based on the number of minutes of screen saver exposure reporting by the end-users during the previous week. A prize would be awarded to one or more randomly selected winners and promoted during the following weeks Lottery ScreenSaver content.

I claim:

1. A personal computer or workstation screen saver application implemented in plurality which monitors activation time and reports same along with identifying information of the user to a host application on a remote server; the remote server subsequently utilizing this information to select a single or multiple winner(s) in a lottery of the users reported.

2. The method of claim 1 whereby the content of the screen saver is provided from a remote host on a scheduled, occasional or on demand basis and contains opportunities to drill down on information of interest, “click thru's”, providing access to additional information which has also been downloaded to the client or remotely referenced via the Internet, these “click thru's” being monitored and routinely reported to the remote server and where subsequent screen saver content may be selected based on the inferred “interests” of the end-users based on this “click thru” data.

3. The method of claims 1 or 2 whereby the lottery chances are based on the number of activations or amount of time the screen saver is active during the reporting period.

4. The method of claim 3 where by the lottery chances may be factored by the activation time or activation time during certain time ranges of the day and/or week and/or by the identity of the end-user based on the business relationship, location, demographic or other criteria of choice.

5. The method of claims 1,2,3 or 4 whereby the screen saver enables proliferation of itself by providing the end-users capability to spawn an email to an address or addresses of choice which contains instructions and/or links to facilitate installation of the screen saver on their personal computer or workstation.

6. The method of claims 1,2,3,4 or 5 where the scheme is implemented on any device with a display.
